(19) United States
(12) Patent Application Publication
(10) Pub. No.: US 2024/0351411 A1
(43) Pub. Date: Oct. 24, 2024

(54) MOTOR VEHICLE CLOSURE PANEL MEDIUM EXPELLING DEVICE AND METHOD

(71) Applicant: David Walter Wright, Boyne City, MI (US)

(72) Inventor: David Walter Wright, Boyne City, MI (US)

(21) Appl. No.: 18/640,727

(22) Filed: Apr. 19, 2024

Related U.S. Application Data
(60) Provisional application No. 63/460,512, filed on Apr. 19, 2023.

(51) Int. Cl. B60J 9/04

(52) U.S. Cl. CPC B60J 9/04

(57) ABSTRACT

An apparatus configured to expel a medium outwardly from an opening of a motor vehicle to inhibit the medium from entering an interior cabin of the motor vehicle upon opening a closure panel closing off the opening, motor vehicle therewith, and method of expelling a medium outwardly from an opening of a motor vehicle. The apparatus includes an air duct and a source of high-pressure air configured to generate high pressure air flow through the air duct to expel the medium outwardly away from the interior cabin.

### CROSS-REFERENCE TO RELATED APPLICATION

This application claims the benefit of U.S. Provisional Application Ser. No. 63/460,512, filed Apr. 19, 2023, which is incorporated herein by reference in its entirety.

### FIELD

The present disclosure relates to closure panels associated with motor vehicles, and more particularly, to mechanisms inhibiting the ingress of a medium into a compartment of the motor vehicle while opening a closure panel closing off the compartment.

### BACKGROUND

This section provides background information related to the present disclosure which is not necessarily prior art.

A problem often occurs upon opening a motor vehicle closure panel, such as vehicle doors, trunks or other closure panels, wherein a medium, such as, but not limited to snow, pollen, or other medium which, enters an opening closed off by the closure panel, thereby causing the intrusion (ingress) of the medium into an interior cabin or compartment of the vehicle. For the sake of this narrative, snow is used as the principal example medium, however, all potential intrusive medium are contemplated and addressed herein. Those living in in a region subject to snow often encounter the ingress of snow into the driver's or passengers' compartment upon opening the door, trunk or other closure panel, particularly when snow is present about a perimeter of the closure panel. This is often due in-part to the “air tight” designs of modern vehicles, aero-dynamics and general vehicle design and configuration. The ingress of snow or other medium results in part from a pressure differential between the exterior of the vehicle and the interior of the vehicle. This pressure differential is due in-part to a vacuum generated within the cabin or compartment upon opening a door or other closure panel. In the case of snow, a passenger seat 15 becomes wet, cold and uncomfortable (FIG. 8). Additionally, snow or other medium may land on sensitive electronic controls 17 located on the door panel (FIG. 9), along a side of the seat 15 or other locations.

In view of the above, what is desired is a mechanism that inhibits the ingress of a medium from an exterior region of the vehicle to an interior of the vehicle upon opening a closure panel. A method and apparatus in accordance with this disclosure provides such method and apparatus.

### SUMMARY

This section provides a general summary of the disclosure, and is not a comprehensive disclosure of its full scope or all of its features.

It is an object of the present disclosure to provide a mechanism that overcomes at least the complications associated with opening closure panels of a motor vehicle discussed above.

It is a further object of the present disclosure to provide a mechanism that inhibits the ingress of a medium into a compartment of a motor vehicle while opening a closure panel that closes off the compartment.

In accordance with the above objects, it is an aspect of the disclosure to provide a mechanism, also referred to as apparatus, to inhibit a medium from entering an interior cabin of a motor vehicle upon opening a closure panel. One non-limiting apparatus dispels the medium outwardly away from the interior cabin prior to the closure panel being opened, and another non-limiting apparatus dispels the medium outwardly from the interior cabin while the closure panel is being opened. The first and second apparatus can be practiced separately or in combination with one another.

In accordance with the above objects, it is an aspect of the disclosure to provide a method to inhibit a medium from entering an interior cabin of a motor vehicle upon opening a closure panel. One non-limiting method dispels the medium outwardly away from the interior cabin prior to the closure panel being opened, and another non-limiting method dispels the medium outwardly from the interior cabin while the closure panel is being opened. The first and second methods can be practiced separately or in combination with one another.

In accordance with one aspect of the disclosure, the apparatus can include a tubular duct with ports, wherein pressurized air is directed to flow through the tubular duct and outwardly through the ports to expel the medium outwardly away from the interior cabin.

In accordance with one aspect of the disclosure, the apparatus can include a tubular duct having a gas permeable region, wherein pressurized air is directed to flow through the tubular duct and outwardly through the permeable region to expel the medium outwardly away from the interior cabin.

In accordance with one aspect of the disclosure, the apparatus can include a tubular duct, wherein pressurized air is directed to flow through the tubular duct to suddenly expand the tubular duct from a radially collapsed state to a radially expanded state to forcibly expel the medium outwardly away from the interior cabin.

In accordance with another aspect of the disclosure, the tubular duct is configured in fluid and/or gas communication, represented as fluid/gas communication, with a source of high pressure air, wherein the source of high pressure air is actuatable in response to an electronic signal.

In accordance with another aspect of the disclosure, the electronic signal can come from a control unit.

In accordance with another aspect of the disclosure, the control unit can be configured to actuate the source of high pressure air, to cause high pressure air to flow through the tubular duct, in response to the closure panel being moved from a closed position toward an open position.

In accordance with another aspect of the disclosure, the control unit can be configured to actuate the source of high pressure air in response to receiving a signal from a sensor and/or switch, wherein the sensor and/or switch can be configured to detect movement of a closure panel latch from a latched position to an unlatched position.

In accordance with another aspect of the disclosure, the control unit can be configured to actuate the source of high pressure air in response to receiving a signal from a key fob.

In accordance with another aspect of the disclosure, the closure panel can include one or more of a door, deck lid and a rear hatch.

In accordance with another aspect of the disclosure, a motor vehicle having a closure panel configured to close off an opening in a closed state, and to provide access to an interior cabin through the opening in an open state includes an apparatus configured to expel a medium outwardly from the opening to inhibit the medium from entering the interior cabin through the opening upon moving the closure panel from the closed state to the open state. The apparatus includes an air duct and a source of high-pressure air configured to generate a high pressure air flow through the air duct and expel the medium outwardly away from the interior cabin.

In accordance with another aspect of the disclosure, a method of expelling a medium outwardly from an opening of a motor vehicle to inhibit the medium from entering an interior cabin of the motor vehicle upon opening a closure panel closing off the opening includes: actuating a source of high pressure air; channeling the high pressure air through an air duct channel extending adjacent at least a portion of the opening, and expelling the medium outwardly away from the interior cabin via the high pressure air.

In accordance with another aspect of the disclosure, the method can further include actuating the source of high pressure air in response to a signal received from a control unit.

In accordance with another aspect of the disclosure, the method can further include configuring the control unit to actuate the source of high pressure air in response to the closure panel being moved from a closed position toward an open position.

In accordance with another aspect of the disclosure, the method can further include configuring the control unit to actuate the source of high pressure air in response to receiving a signal from a sensor and/or switch, and configuring the sensor and/or switch to detect movement of a closure panel latch from a latched position to an unlatched position and/or movement of a closure panel lock mechanism to an unlocked state.

In accordance with another aspect of the disclosure, the method can further include configuring the control unit to actuate the source of high pressure air in response to receiving a signal from a key fob.

In accordance with another aspect of the disclosure, the method can further include providing the air duct including at least one of a plurality of ports, a gas permeable material, and an expandable region, and causing the source of high-pressure air to channel the air to flow outwardly from the air duct through the plurality of ports and/or through the gas permeable material, and/or to expand the expandable region, to expel the medium outwardly away from the interior cabin.

In accordance with another aspect of the disclosure, the method can further include providing the air duct to include a plurality of ports.

In accordance with another aspect of the disclosure, the method can further include configuring the source of high-pressure air for actuation by at least one of user input and a pre-programmed set of parameters.

In accordance with another aspect of the disclosure, the method can further include providing the pre-programmed set of parameters to include sensors configured to detect the presence of the medium.

In accordance with another aspect of the disclosure, the method can further include configuring the sensors to detect an amount of accumulation of the medium based on at least one of in-situ monitoring of an environment adjacent the vehicle and locally reported weather condition data.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric view of a vehicle having a medium expelling apparatus in accordance with one aspect of the disclosure;

FIG. 2 is a cross section of the vehicle thru A-A as denoted in FIG. 1 illustrating an air-blowoff duct of the medium expelling apparatus;

FIG. 3 is a cross section of vehicle thru A-A as denoted in FIG. 1 illustrating a throw-off duct of the medium expelling apparatus in accordance with another aspect of the disclosure;

FIG. 4 is a close-up of area B denoted in FIG. 3 with the throw-off duct in a non-deployed, retracted state;

FIG. 5 is a close-up of area B denoted in FIG. 3 with throw-off duct in a deployed, expanded state;

FIG. 6 is a cross section of the vehicle thru A-A as denoted in FIG. 1 illustrating an air-blow-off duct of the medium evacuation apparatus in accordance with another aspect of the invention;

FIG. 7 is a Logic Block Diagram of the vehicle control and actuation system;

FIG. 8 illustrates a medium on seat, with a closure panel removed for clarity purposes only, in accordance with the prior art; and

FIG. 9 illustrates a medium on inner door controls and handle in accordance with the prior art.

Corresponding reference numerals indicate corresponding parts throughout the several views of the drawings.

### DETAILED DESCRIPTION OF EXAMPLE EMBODIMENTS

Example embodiments will now be described more fully with reference to the accompanying drawings.

The present disclosure is directed to one or more embodiments of a closure panel with a medium expelling apparatus therefor. The closure panels and media expelling apparatus of the present disclosure and methods expelling media from entering an interior cabin of a motor vehicle are clearly illustrated in the appended drawings and those skilled in the art will fully comprehend all aspects, features and improvements associated therewith.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

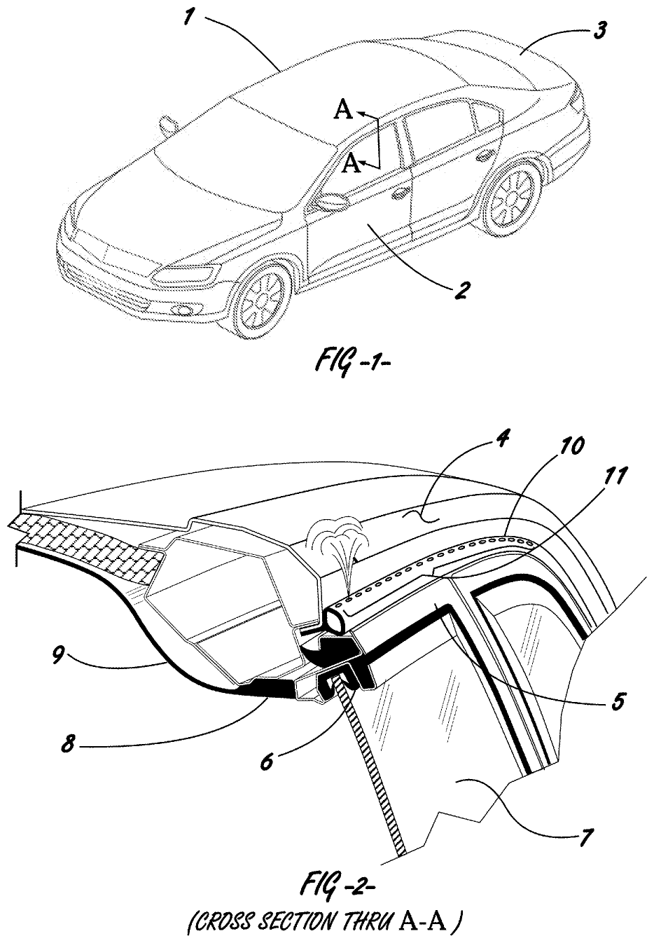

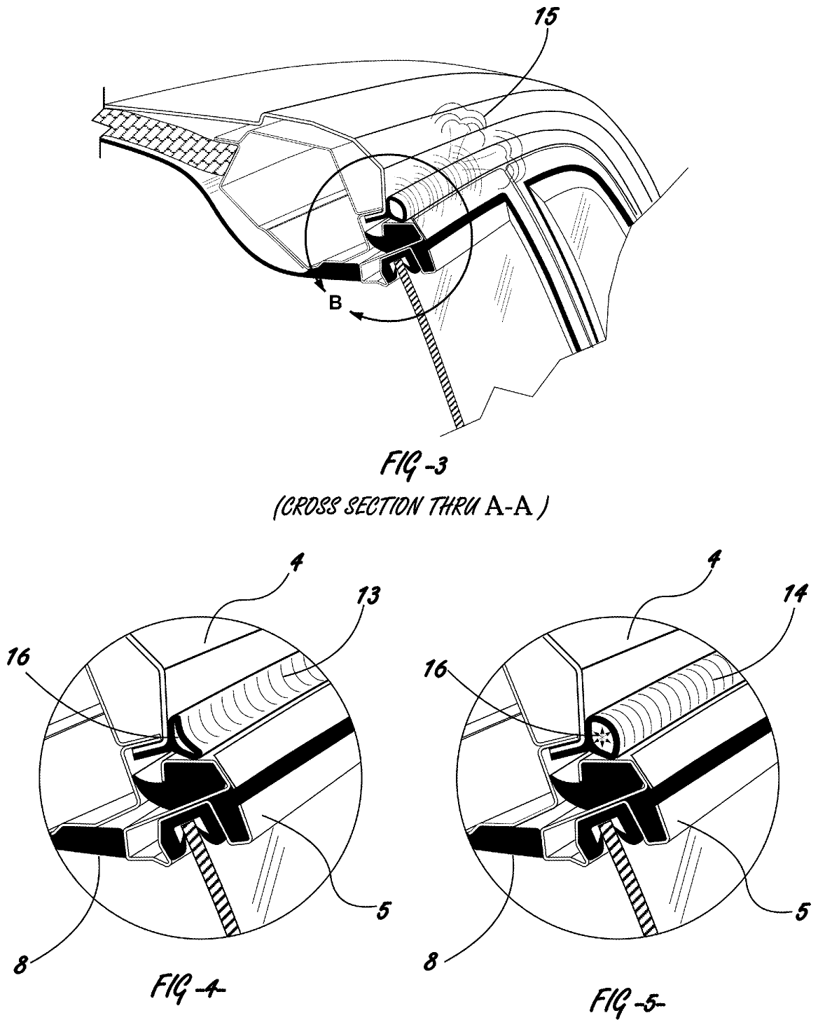

Referring in more detail to the drawings, FIG. 2, derived from the cross section A-A in FIG. 1, an apparatus, including an air duct channel 10 in accordance with one non-limiting aspect of the disclosure, having of a plurality of air duct ports 11 extending through a wall of the air duct channel 10, such that air duct ports 11 communicate an internal cavity 16 with an outside environment, extends along and adjacent at least a portion of an opening, closed off by a door frame 5, and along and adjacent at least a portion of an outer periphery of a closure panel, such as a passenger door 2 and/or a deck lid, also referred to as trunk lid 3, closing off the opening. The air duct channel 10 can be affixed to the vehicle cant rail 4 adjacent the opening closed off by the closure panel 2 while in a closed state, or to the closure panel 2, 3 itself, particularly along the upper surface of the closure panel 2 and along the roof, as shown, where the medium 15 is most likely to gather and fall downwardly upon moving the closure panel 2 to an open state. The air duct channel 10 receives a sudden burst of air 12 under high pressure, referred to as high pressure air 12, from a high pressure air source 21 (FIG. 7), whereupon the high pressure air 12 flows through the cavity 16 of air duct channel 10 and outwardly from the cavity 16 of air duct channel 10 through the air duct ports 11. It is to be recognized that the air duct ports 11 can be located precisely where it is most desired to expel the medium 15, such as along and adjacent at least a portion of the opening closed off by the closure panel 2, 3. It is to be recognized that the high pressure air source 21 can provide a constant pressure source of high pressure air 12, or a pulsed pressure source of high pressure air 12, such that the pressure of the high pressure air rises and fall cyclically from high pressure to low pressure in any desired frequency. Further yet, the high pressure air 12 can be heated, such as from a vehicle heater system or otherwise, to effectively melt the medium 15 as desired, wherein the temperature of the high pressure air 12 can be selectively varied, as desired, by a temperature control (thermostat) switch, such as used to control the internal air temperature of the motor vehicle 1.

Air source 21 can be energized to pump air under high pressure in response to a signal from a vehicle control system, also referred to as control unit 20, as shown in FIG. 7, in accordance with input from a remote control (e.g., user input via a key fob, cell phone, button within the vehicle cabin, or otherwise) 18 or other determining action, such as a pre-programmed set of parameters 19, for example, movement of a powered door latch component, including a pawl, and/or ratchet, and/or release lever, and/or power release gear, and/or movement of a closure panel lock mechanism to an unlocked state, or other mechanism associated with the closure panel 2, including a door handle, by way of example and without limitation, whereat the high pressure air 12 results in the sudden removal of a medium 15, such as snow or water, from about the closure panels 2, 3 prior to movement of closure panel 2, 3 from the closed position. Accordingly, immediately prior to and/or during movement of closure panel 2, 3, from the closed position, the medium 15 is expelled and evacuated (blown or pushed) outwardly away from the closure panel 2, 3. Accordingly, the medium 15 is prevented from entering the opening into the interior cabin of the motor vehicle 1.

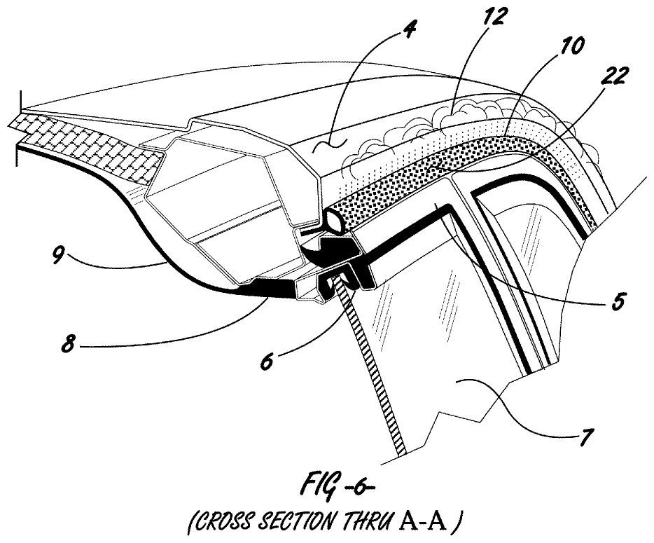

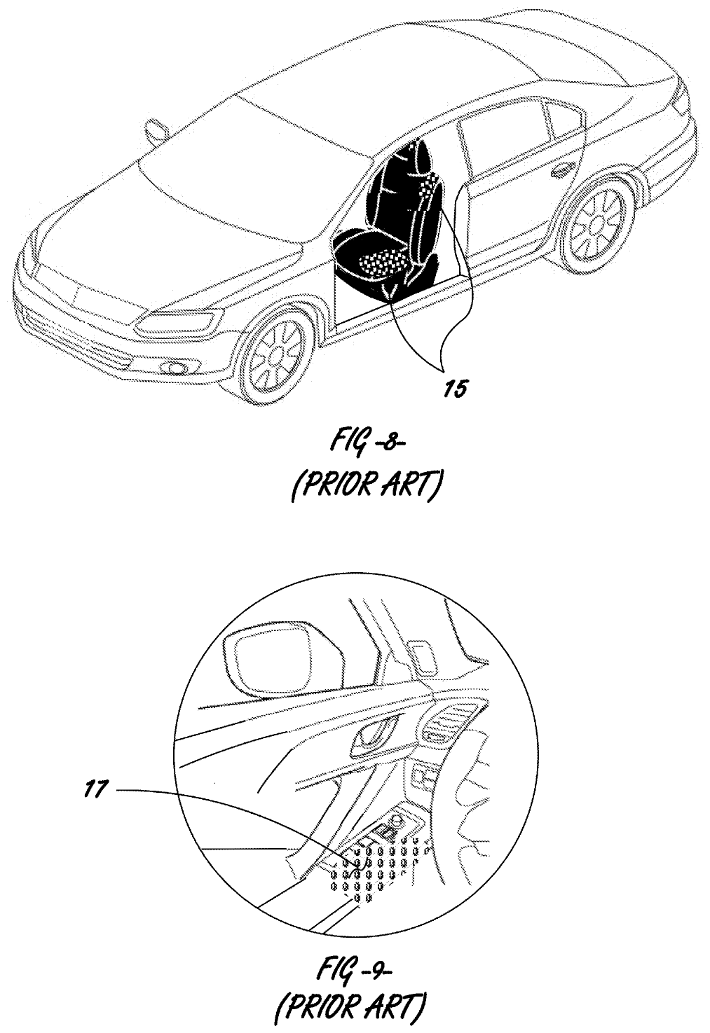

Referring to the drawings, FIGS. 3, 4 and 5 illustrate another non-limiting embodiment utilizing a sudden burst of air 12 from the air source 21 (FIG. 8), as described in the previous embodiment, makes use of an inflatable duct, also referred to as boot (collapsed or deflated 13), (expanded or inflated 14), respectively. Referring to FIG. 4, the duct (boot) 13, while in the unactuated, collapsed state 13, affixed to the vehicle cant rail 4 or to the closure panel 2, receives a sudden burst of air 12 from the air source 21 (FIG. 7) through the cavity 16, as discussed above in the previous embodiment, thereby resulting in the removal of the medium 15 by suddenly expanding the wall, also referred to as duct (boot) 14, extending about or along at least a portion of the closure panels 2, 3 prior to opening closure panel 2. The sudden expansion of the duct 14 causes the medium 15 to be forcibly ejected (pushed, thrown) outwardly away from the closure panel 2, 3, thereby preventing the medium 15 from passing through the opening and entering the interior cabin of the motor vehicle 1.

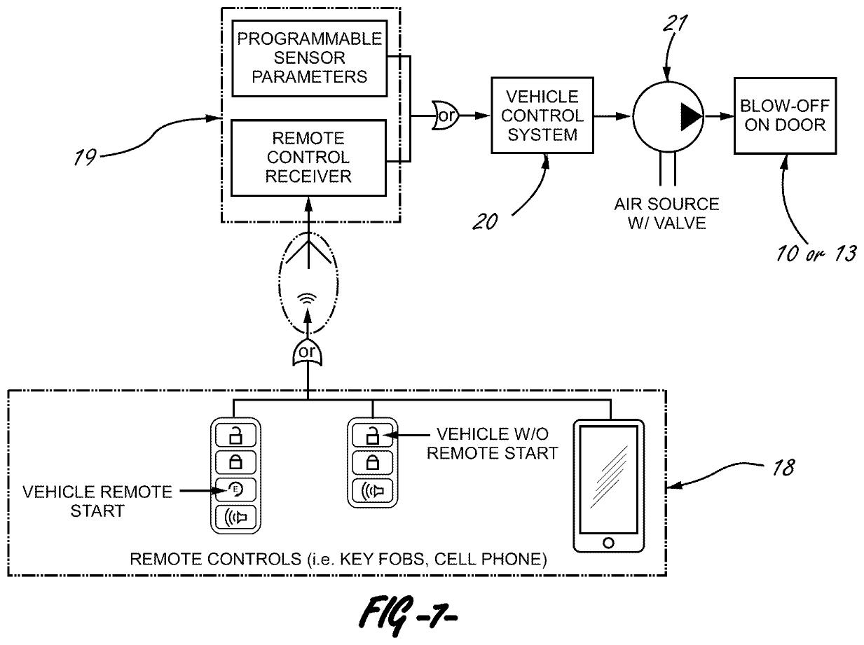

Referring now to FIG. 6, another non-limiting embodiment utilizing a sudden burst of air 12 through the cavity from the air source 21 (FIG. 7), as described in the previous embodiments, makes use of a wall, also referred to as duct (boot) 22, having a gas permeable material extending over at least the portion of the duct 22. The gas permeable material, such as woven material or gas permeable membrane, is present wherever it is desired to have a medium 15, such as discussed above, expelled outwardly away from the closure panel 2, 3, thereby preventing the medium 15 from entering passing through the opening and the interior cabin of the motor vehicle 1. The sudden burst of high pressure air 15 from the air source 21 is generated as discussed above via air source 21, and thus, further description is believed unnecessary. The gas permeable material of the duct 22 can be specifically limited to a region over which it is desired to expel the medium 15, thereby maximizing the pressure and force produced by the air flowing outwardly from the duct 22 through the gas permeable region of the duct 22.

It is to be understood that the source of energy to power air source 21 can be a main battery of vehicle. Otherwise, a supplemental battery, capacitor, or otherwise, can be provided. It is also to be understood that the ducts 22 discussed above can be provided as an integral portion of a closure panel seal, such as illustrated above a window seal 6 in FIG. 2, also referred to as weather stripping or seal strip, which also applies to a cant rail seal 8 shown adjacent a headliner 9 in FIG. 2, or as a separate member from a door seal, as desired. Accordingly, the duct 22 can be multifunctional, acting to form an air-tight, weatherproof seal between the closure panel 2, 3 and the vehicle body and to expel medium outwardly from the closure panel 2, 3, if desired.

In accordance with another aspect of the disclosure, a motor vehicle 1 having a closure panel 2, 3 configured to close off an opening in a closed state, and to provide access to an interior cabin through the opening in an open state includes an apparatus, as discussed above, configured to expel a medium 15 outwardly from the opening to inhibit the medium 15 from entering the interior cabin through the opening upon moving the closure panel 2, 3 from the closed state to the open state. The apparatus includes an air duct 10 and a source of high-pressure air 21 configured to cause air 12 to flow through the air duct 10 under high pressure and expel the medium 15 outwardly away from the interior cabin.

In accordance with another aspect of the disclosure, a method of expelling a medium 15 outwardly from an opening of a motor vehicle 1 to inhibit the medium 15 from entering an interior cabin of the motor vehicle 1 upon opening a closure panel 2 closing off the opening includes: actuating a source of high pressure air 21 to generate high pressure air 12; channeling the high pressure air 12 through a cavity 16 of an air duct channel 10 extending adjacent at least a portion of the opening, and expelling the medium 15 outwardly away from the interior cabin via the high pressure air 12.

In accordance with another aspect of the disclosure, the method can further include actuating the source of high pressure air 21 in response to a signal received from a control unit 20.

In accordance with another aspect of the disclosure, the method can further include configuring the control unit 20 to actuate the source of high pressure air 12 in response to the closure panel 2, 3 being moved from a closed position toward an open position.

In accordance with another aspect of the disclosure, the method can further include configuring the control unit 20 to actuate the source of high pressure air 12 in response to receiving a signal from a sensor and/or switch 19, and configuring the sensor and/or switch 19 to detect movement of a closure panel latch from a latched position to an unlatched position and/or movement of a closure panel lock mechanism to an unlocked state.

In accordance with another aspect of the disclosure, the method can further include configuring the control unit 20 to actuate the source of high pressure air 21 in response to receiving a signal from a key fob 18.

In accordance with another aspect of the disclosure, the method can further include providing the air duct 10 including at least one of a plurality of ports 11, a gas permeable material 22, and an expandable region 13, and causing the source of high-pressure air 21 to channel the high pressure air 12 to flow outwardly from the air duct 10 through the plurality of ports 11 and/or through the gas permeable material 22, and/or to expand 14 the expandable region 13, to expel the medium 15 outwardly away from the interior cabin.

In accordance with another aspect of the disclosure, the method can further include providing the air duct 10 to include a plurality of ports 11.

In accordance with another aspect of the disclosure, the method can further include configuring the source of high-pressure air 21 for actuation by at least one of user input 18 and a pre-programmed set of parameters 19.

In accordance with another aspect of the disclosure, the method can further include providing the pre-programmed set of parameters 19 to include sensors configured to detect the presence of the medium.

In accordance with another aspect of the disclosure, the method can further include configuring the sensors to detect an amount of accumulation of the medium based on at least one of in-situ monitoring of an environment adjacent the motor vehicle 1 and locally reported weather condition data.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus configured to expel a medium outwardly from an opening of a motor vehicle to inhibit the medium from entering an interior cabin of the motor vehicle upon opening a closure panel closing off the opening, the apparatus comprising:
an air duct; and
a source of high-pressure air configured to generate a flow of high pressure air through the air duct, wherein the high pressure air expels the medium outwardly away from the interior cabin.

2. The apparatus of claim 1, wherein the air duct includes at least one of a plurality of ports, a gas permeable material, and an expandable region, wherein the source of high-pressure air causes the high pressure air to flow outwardly from the air duct through the plurality of ports and/or through the gas permeable material, and/or to expand the expandable region, to expel the medium outwardly away from the interior cabin.

3. The apparatus of claim 2, wherein the air duct includes a plurality of ports.

4. The apparatus of claim 2, wherein the source of high-pressure air is configured for actuation by at least one of user input and a pre-programmed set of parameters.

5. The apparatus of claim 4, wherein the pre-programmed set of parameters include sensors configured to detect the presence of the medium.

6. The apparatus of claim 5, wherein the sensors are configured to detect an amount of accumulation of the medium based on at least one of in-situ monitoring of an environment adjacent the vehicle and locally reported weather condition data.

7. The apparatus of claim 1, further including a control unit, wherein the source of high pressure air is actuatable to cause the high pressure air to flow through the air duct in response to a signal from the control unit.

8. The apparatus of claim 7, wherein the control unit is configured to actuate the source of high pressure air in response to the closure panel being moved from a closed position toward an open position.

9. The apparatus of claim 7, wherein the control unit is configured to actuate the source of high pressure air in response to receiving a signal from a sensor and/or switch, wherein the sensor and/or switch is configured to detect movement of a closure panel latch from a latched position to an unlatched position and/or movement of a closure panel lock mechanism to an unlocked state.

10. The apparatus of claim 7, wherein the control unit is configured to actuate the source of high pressure air in response to receiving a signal from a key fob.

11. A motor vehicle having a closure panel configured to close off an opening in a closed state, and to provide access to an interior cabin through the opening in an open state, the motor vehicle comprising:
an apparatus configured to expel a medium outwardly from the opening to inhibit the medium from entering the interior cabin through the opening upon moving the closure panel from the closed state to the open state, the apparatus having an air duct and a source of high-pressure air configured to cause high pressure air to flow through the air duct and expel the medium outwardly away from the interior cabin.

12. The motor vehicle of claim 11, wherein the air duct includes at least one of a plurality of ports, a gas permeable material, and an expandable region, wherein the source of high-pressure air causes the high pressure air to flow outwardly from the air duct through the plurality of ports and/or through the gas permeable material, and/or to expand the expandable region, to expel the medium outwardly away from the interior cabin.

13. The motor vehicle of claim 12, wherein the source of high-pressure air is configured for actuation by at least one of user input and a pre-programmed set of parameters.

14. The motor vehicle of claim 13, wherein the pre-programmed set of parameters include sensors configured to detect the presence of the medium.

15. The motor vehicle of claim 11, further including a control unit, wherein the source of high pressure air is actuatable to cause the high pressure air to flow through the air duct in response to a signal from the control unit.

16. The apparatus of claim 15, wherein the control unit is configured to actuate the source of high pressure air in response to the closure panel being moved from a closed position toward an open position.

17. The apparatus of claim 15, wherein the control unit is configured to actuate the source of high pressure air in response to receiving a signal from a sensor and/or switch, wherein the sensor and/or switch is configured to detect movement of a closure panel latch from a latched position to an unlatched position and/or movement of a closure panel lock mechanism to an unlocked state.

18. The apparatus of claim 15, wherein the control unit is configured to actuate the source of high pressure air in response to receiving a signal from a key fob.

19. A method of expelling a medium outwardly from an opening of a motor vehicle to inhibit the medium from entering an interior cabin of the motor vehicle upon opening a closure panel closing off the opening, comprising:
actuating a source of high pressure air to generate high pressure air;
channeling the high pressure air through an air duct channel extending adjacent at least a portion of the opening; and
expelling the medium outwardly away from the interior cabin via the high pressure air.

20. The method of claim 19, further including actuating the source of high pressure air in response to a signal received from a control unit.
